(19) United States
(12) Patent Application Publication
(10) Pub. No.: US 2020/0380424 A1
(43) Pub. Date: Dec. 3, 2020

(54) INFORMATION PROCESSING APPARATUS, RESERVATION SYSTEM, AND NON-TRANSITORY COMPUTER READABLE MEDIUM STORING PROGRAM

(71) Applicant: FUJI XEROX CO., LTD., Tokyo (JP)

(72) Inventors: Akihide KAWAMURA, Kanagawa (JP); Shu WATANABE, Kanagawa (JP); Kunichi YAMASHITA, Kanagawa (JP)

(73) Assignee: FUJI XEROX CO., LTD., Tokyo (JP)

(21) Appl. No.: 16/714,776

(22) Filed: Dec. 15, 2019

(30) Foreign Application Priority Data
May 30, 2019 (JP) 2019-101790

(51) Int. Cl. G06Q 10/02; G07C 9/32; G07C 9/38

(52) U.S. Cl. CPC G06Q 10/02; G07C 9/38; G07C 9/32

(57) ABSTRACT

An information processing apparatus includes a recognition unit that recognizes arrival of a user at a reservable space, and a switch unit that, in a case where the user is allowed to use the reservable space, switches from a state of blocking usage of the reservable space by the user to a state of not blocking the usage of the reservable space.

### CROSS-REFERENCE TO RELATED APPLICATIONS

This application is based on and claims priority under 35 USC 119 from Japanese Patent Application No. 2019-101790 filed May 30, 2019.

### BACKGROUND

### (i) Technical Field

The present invention relates to an information processing apparatus, a reservation system, and a non-transitory computer readable medium storing a program.

### (ii) Related Art

There is a service which is capable of making a reservation for occupation of a space in units of time of today from a private room-type space whose periphery is surrounded by a wall or the like to an open-type space which is not surrounded. For example, a service for making a reservation for occupation of a private room-type space, which is installed in a station or a passageway, in units of time is put to practical use. The service enables effective use of spare time on the move.

JP2014-066079A discloses a gate electronic key management method including: a reservation application procedure in which one subscriber portable terminal specifies a gate and use time, respectively, with respect to a gate management server, a shared authority issuance procedure in which the gate management server issues at least shared authority with respect to the subscriber portable terminal in a case where reservation is completed, a shared authority giving procedure in which the subscriber portable terminal performs communication with one or more user portable terminals to give the shared authority with respect to the user portable terminal, an electronic key information giving procedure in which the gate management server gives electronic key information where gate information and effective time information are associated with a unique lock ID, respectively, with respect to the user portable terminal in a case where the user portable terminal presents the shared authority through a communication network and the shared authority is OK, and a unlocking procedure in which an electric lock device unlocks a shielding member or a lock of the gate in a case where the unique lock ID of the electronic key information of the user portable terminal matches the electric lock device.

In addition, JP2018-010619A discloses a determination apparatus which includes an acquisition unit and a determination unit. The acquisition unit acquires information relevant to a usage period of a prescribed space by a user. The determination unit determines a provision style of a service to be provided to the user, including association of information relevant to a body of the user detected by a prescribed sensor provided in the prescribed space with information relevant to the body of the user acquired in a space other than the prescribed space, during the usage period of the prescribed space acquired by the acquisition unit.

### SUMMARY

There is a case where a usage target, such as equipment or a space, which is shared and used by a plurality of persons, is installed in a locking space which is capable of being locked. Further, in a case where a user who tries to use the usage target releases locking, it is possible to use the usage target. However, there is a case where a large amount of costs are necessary to manage the locking space. In addition, it is necessary for the user to acquire a predetermined key to release the locking, and thus there is a case where the user feels troublesomeness. In contrast, in a case where the usage target is not installed in the locking space, it may be difficult to perform the management.

Aspects of non-limiting exemplary embodiments of the present disclosure relate to an information processing apparatus, a reservation system, and a non-transitory computer readable medium storing a program, which are capable of easily managing the usage target.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a recognition unit that recognizes arrival of a user at a reservable space; and a switch unit that, in a case where the user is allowed to use the reservable space, switches from a state of blocking usage of the reservable space by the user to a state of not blocking the usage of the reservable space.

### BRIEF DESCRIPTION OF THE DRAWINGS

Exemplary embodiment(s) of the present invention will be described in detail based on the following figures, wherein:

FIG. 1 is a diagram schematically illustrating an example of a whole configuration of a management system used in an exemplary embodiment;

FIG. 2 is a diagram illustrating an example of a space;

FIG. 3 is a diagram illustrating an example of a hardware configuration of a user terminal used in the exemplary embodiment;

FIG. 4 is a diagram illustrating an example of a hardware configuration of a management server used in the exemplary embodiment;

FIG. 5 is a block diagram illustrating a functional configuration of a management system according to a first exemplary embodiment;

Parts (a) to (f) in FIG. 6 are diagrams illustrating a first detailed example in a case where a user tries to use the space;

Parts (a) and (b) in FIG. 7 are diagrams illustrating a second detailed example in the case where the user tries to use the space;

Parts (a) to (c) in FIG. 8 are diagrams illustrating a third detailed example in the case where the user tries to use the space;

FIG. 9 is a diagram illustrating an example of management data managed by the management server;

FIG. 10 is a flowchart illustrating a whole operation of the management system according to the first exemplary embodiment;

FIG. 11 is a block diagram illustrating a functional configuration of a management system according to a second exemplary embodiment; and

FIG. 12 is a flowchart illustrating a whole operation of the management system according to the second exemplary embodiment.

### DETAILED DESCRIPTION

Hereinafter, exemplary embodiments of the present invention will be described in detail with reference to the accompanying drawings.

Due to miniaturization of communication equipment, high communication speed, and the like, an opportunity for today's businessperson of performing work in a space other than a seat increases. For example, attendance at a meeting, a visit to a customer, and the like are examples of the work which is performed in the space other than the seat. In addition, for the purpose of effective use of time, there is a case of performing the work in a previously reserved space during spare time on the move.

Whole Configuration of Management System 1

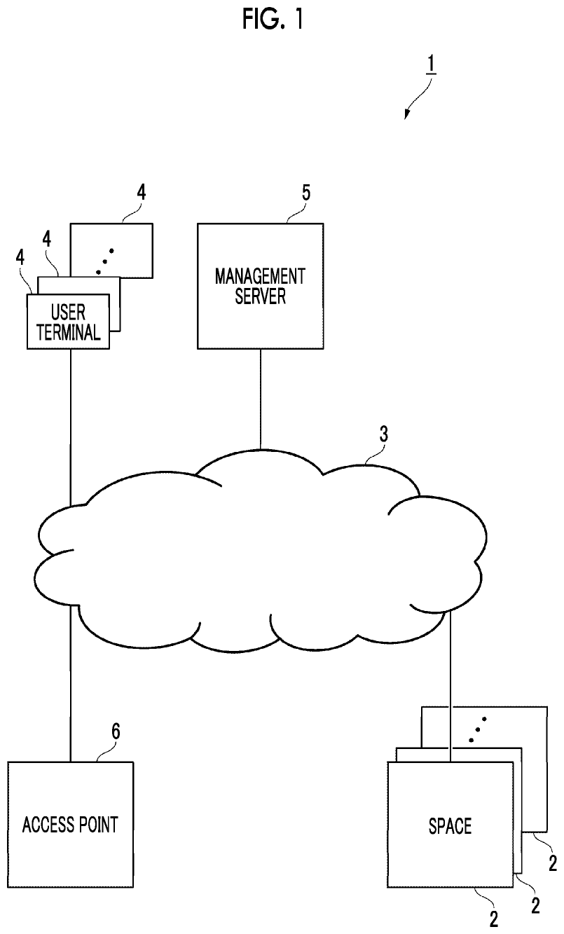

FIG. 1 is a diagram schematically illustrating an example of a whole configuration of a management system 1 used in an exemplary embodiment.

The management system 1 according to the exemplary embodiment has an object to provide a service for lending a space 2 to the user.

The space 2 according to the exemplary embodiment is a so-called open space, and is, for example, a space which is opened to unspecified many individuals. Accordingly, the space 2 is not a closed space, such as a meeting room, which is separated from a periphery by a wall, a partition, or the like, and is not locked. However, separation of the space 2 by the partition or the like is not prohibited. It is possible to set the space 2 to a space in which anybody is able to enter. An example of a place, at which the space 2 is set up, includes, for example, a lobby of a hotel, a waiting room of a railway station, a departure lobby of an airport, a restaurant, such as a cafe or a family restaurant, a vehicle parking lot, a bicycle parking lot, or the like.

Meanwhile, it is not necessary that the unspecified many individuals are definitely relationless persons, and the unspecified many individuals may be, for example, a plurality of persons who have a predetermined relationship. In this case, the predetermined relationship corresponds to, for example, a case of employees in a company. At this time, the place, at which the space 2 is set up, is a discussion space or the like in the company. In addition, as another example, the predetermined relationship corresponds to, for example, a case of members who are capable of receiving a specified service. At this time, the place, at which the space 2 is set up, is a membership lounge of an airport.

In addition, a concept of the space 2 according to the exemplary embodiment includes a target which is disposed in the space 2 and is used by the user. That is, the space 2 is a three-dimensional space which has a predetermined occupied area, and includes equipment and fixtures which are disposed therein. The target corresponds to, for example, a table, a desk, a chair, a PC, a display, a television, a game terminal, communication equipment, such as a telephone or a smart phone, a dictionary, and the like.

Further, for management, a name, a number, or the like may be given to the space 2 according to the exemplary embodiment. Furthermore, the usage of the space 2 may be charged or may be free.

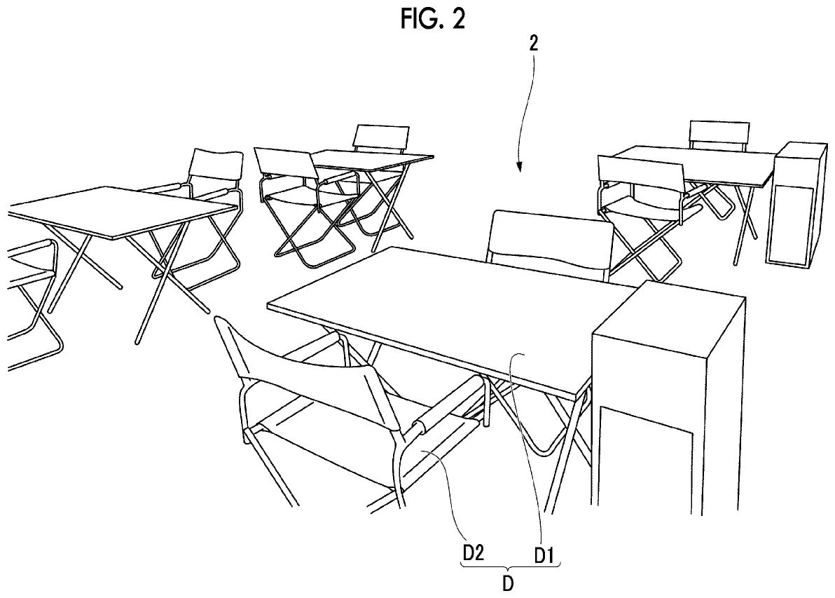

FIG. 2 is a diagram illustrating an example of the space 2.

The space 2 illustrated in FIG. 2 is a part of the restaurant, such as the cafe, and includes a table D1 and a chair D2 as a target D to be used by the user. The space 2 does not include a division or the like from an adjacent space, and it is possible to freely enter the space 2 from a passageway or the like.

Returning to FIG. 1, the management system 1 includes various terminals coupled to a cloud network 3.

FIG. 1 illustrates the space 2 which is a reservation target, a user terminal 4 which is manipulated by the user, a management server 5 which manages the space 2, and an access point 6 which receives a result or the like acquired by recognizing the user who uses the space 2, as an example of the terminal coupled to the cloud network 3.

However, a case may be conceivable where the space 2 does not have a function as the terminal as in the table, the chair or the like at which a subscriber or the like receives provision of the service.

A service provider who manages the space 2 may be single or plural. For example, different service providers may respectively perform division of management for a reservation, a usage situation, or the like of the space 2, management relevant to charging for usage fees with respect to the user, and management for members registered as the user.

As described above, it is also not necessary that the space 2 managed as the reservation target is the same type. For example, a part of the space 2 may be the table and a part of the space 2 may be the chair. In addition, management for one object or function may be cooperatively provided by a plurality of service providers.

In the exemplary embodiment, a smart phone, which is portable by the user, is assumed as the user terminal 4. However, the portable user terminal 4 may be a so-called wearable terminal, a note-type computer, or a game terminal.

The management server 5 manages various types of information related to the space 2. The management server 5 manages, for example, information for specifying the subscriber of the space 2, information for specifying the space 2 which is the reservation target, date and time in which the reservation starts, date and time in which the reservation ends, and payment-related information for the space 2.

The information for specifying the subscriber as the user includes, for example, a name, a gender, an age, an account, and a password of the subscriber, and information given to the individual for management. In addition, the information for specifying the space 2 which is the reservation target includes, for example, information for specifying an address or a resident place, and a name or a number for management.

Meanwhile, the management server 5 may manage reservation of an article or a service associated with the space 2. For example, the management server 5 may manage an article or a service, which can be allowed to be lent or used, and an article or a service which is consumed or exhausted.

The access point 6 receives a recognition result or a payment result of the user who uses the space 2. The access point 6 is equipment which performs wireless communication using a wireless communication line such as a wireless Local Area Network (LAN). The access point 6 mediates transmission and reception of information between the space 2 and the management server 5.

It is possible to use respective lines, such as a mobile phone line, a Personal Handy-phone System (PHS) line, Wireless Fidelity (Wi-Fi), Bluetooth (registered trademark), ZigBee, and Ultra Wideband (UWB), as the type of the wireless communication line.

Meanwhile, in the exemplary embodiment, the recognition result or the payment result of the user who uses the space may be coupled to the cloud network 3 using a wired communication line, such as a wired LAN, instead of the wireless communication line. In this case, the access point 6 is not necessary.

Detailed Configuration of Terminal

Subsequently, respective detailed configurations of the user terminal 4 and the management server 5 will be described.

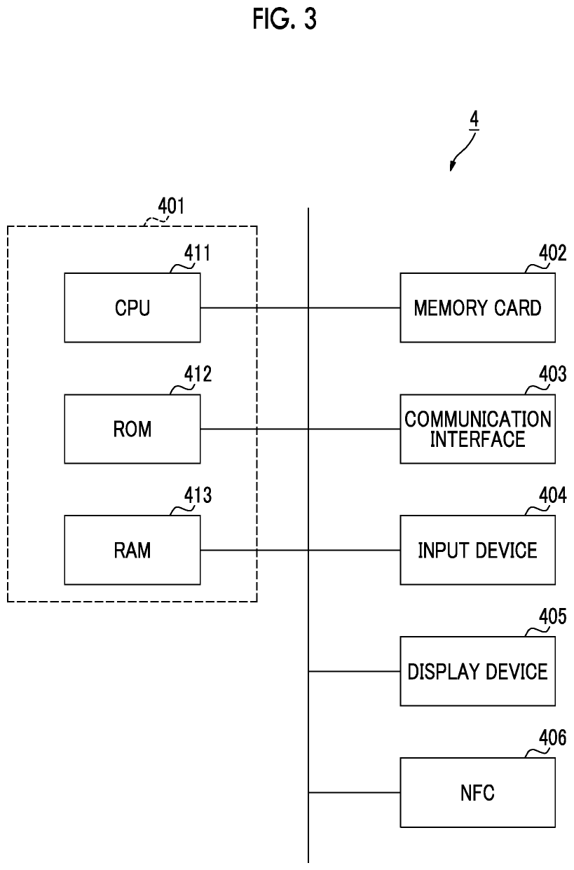

FIG. 3 is a diagram illustrating an example of a hardware configuration of the user terminal 4 used in the exemplary embodiment. The configuration illustrated in FIG. 3 assumes a case where the user terminal 4 is the smart phone.

The user terminal 4 includes a control unit 401 which controls a whole operation of a device, a memory card 402 which stores various types of data, various types of communication interfaces 403 in conformity with wireless communication standards, an input device 404 such as a touch sensor, a display device 405 such as a liquid crystal display or an organic Electro Luminescence (EL) display, and a Near Field Communication (NFC) 406 which performs a recognition of a user or makes a payment.

The control unit 401 includes a Central Processing Unit (CPU) 411, a Read Only Memory (ROM) 412 which stores a firmware, a Basic Input Output System (BIOS), or the like, and a Random Access Memory (RAM) 413 which is used as a work area. The CPU 411 may be a multicore. In addition, the ROM 412 may be a rewritable non-volatile semiconductor memory.

The communication interface 403 is, for example, an interface used to couple a mobile communication system, and an interface used to couple a wireless LAN.

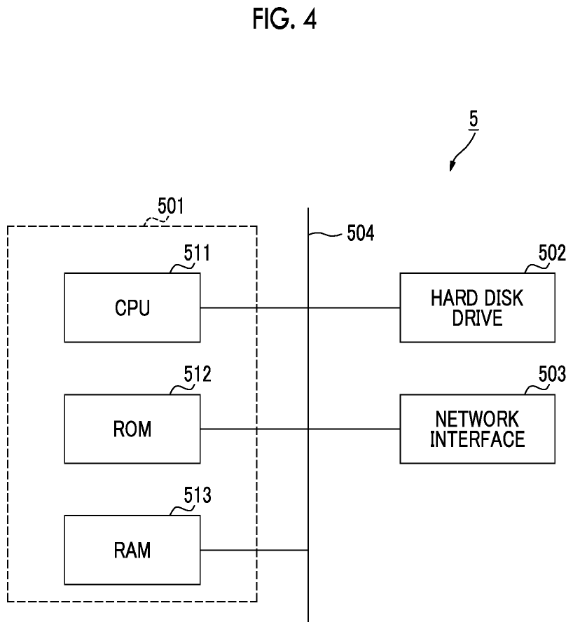

FIG. 4 is a diagram illustrating an example of a hardware configuration of the management server 5 used in the exemplary embodiment.

The management server 5 includes a control unit 501 which controls a whole operation of a device, a hard disk drive 502 which stores management data or the like, and a network interface 503 which realizes communication through a Local Area Network (LAN) cable or the like.

The control unit 501 includes a CPU 511, a ROM 512 which stores basic software, BIOS, and the like, and a RAM 513 which is used as the work area. The CPU 511 may be a multicore. In addition, the ROM 512 may be a rewritable non-volatile semiconductor memory. The control unit 501 is a so-called computer.

The hard disk drive 502 is a device for reading and writing data from and to a non-volatile storage medium which has a disk-shaped substrate surface coated with a magnetic substance. However, the non-volatile storage medium may be a semiconductor memory or a magnetic tape.

In addition, the management server also includes an input device, such as a keyboard or a mouse, and a display device, such as a liquid crystal display, if necessary.

The control unit 501, the hard disk drive 502, and the network interface 503 are coupled through a bus 504 or a not-illustrated signal line.

### First Exemplary Embodiment

Detailed Description of Management System 1

Subsequently, a first exemplary embodiment of the management system 1 will be described. In the first exemplary embodiment, the user makes a reservation to use the space 2 in advance. That is, the user is the subscriber. Hereinafter, a case where the user uses the space 2 on a reservation date will be described. In this case, the management system 1 functions as a reservation system.

Although details will be described later, at this time, before the user uses the space 2, the target D included in the space 2 is in a state of blocking the usage of the space 2. Further, in a case where the user who makes the reservation is certified and the user uses the space 2, the target D is in a state of not blocking the usage of the space 2. That is, in a case where the usage of the space 2 is allowed with respect to the recognized user, the state of blocking the usage of the space 2 is switched to the state of not blocking the usage of the space 2.

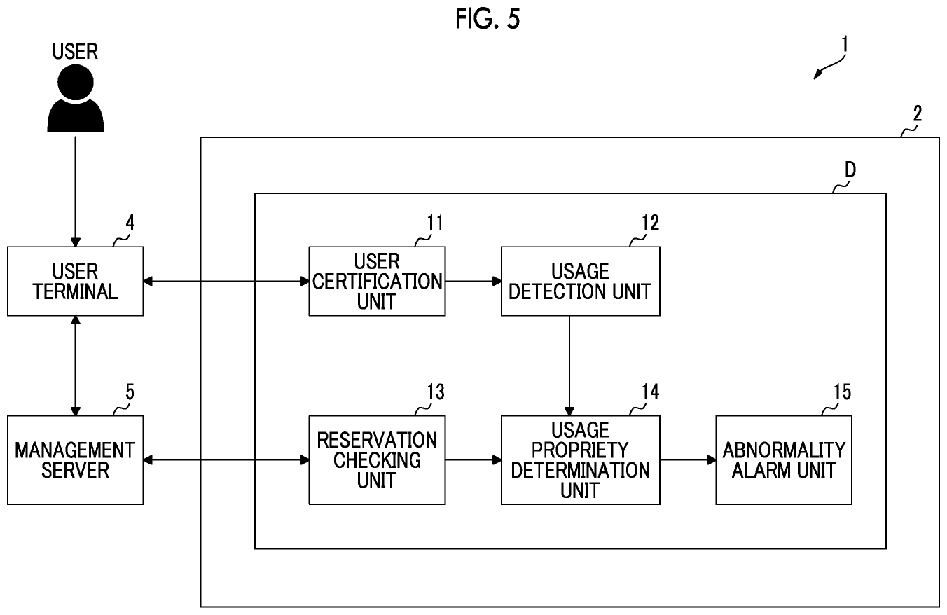

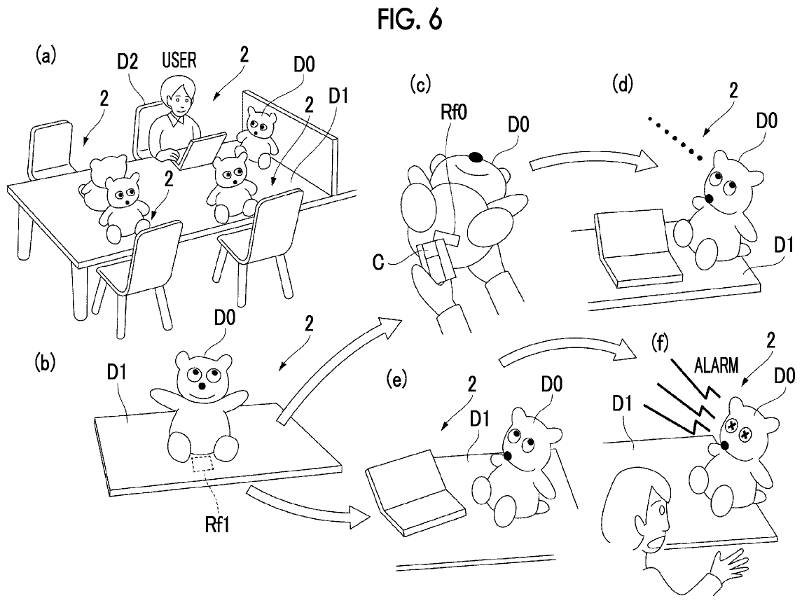

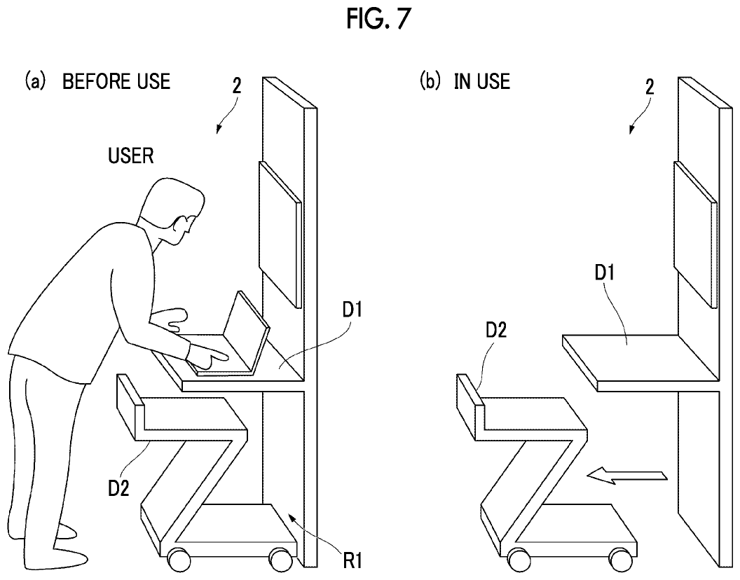

FIG. 5 is a block diagram illustrating a functional configuration of the management system 1 according to the first exemplary embodiment.

The management system 1 illustrated in the drawing includes the user terminal 4 and the management server 5, which are described above, and the target D which is included in the space 2. As described above, the target D may be the equipment or the fixtures, such as the table and the chair, which are actually used by the user in the space 2. In addition, it is possible to understand the target D as an information processing unit or an information processing apparatus for allowing the usage of the space 2 with respect to the user who makes the reservation.

The user terminal 4 is a smart phone or the like which is portable for the user, as described above. The user designates the date and time and makes the reservation for the space 2 by manipulating an application on the user terminal 4.

The management server 5 manages the reservation. That is, in a case where the user is desired to make a reservation of the space 2 using the user terminal 4, the management server 5 determines whether or not it is possible to make the reservation on the designated date and time. Further, in a case where it is possible to make the reservation, the management server 5 registers the reservation and provides a notification to the user terminal 4. Further, the user terminal 4 performs display, which indicates that the reservation is completed, on the display device 405 (see FIG. 3). In contrast, in a case where it is not possible to make the reservation because a reservation of another user is already entered, the management server 5 provides a notification, which indicates that it is not possible to make the reservation, to the user terminal 4. Further, the user terminal 4 performs display, which indicates that it is not possible to make the reservation, on the display device 405. The management server 5 functions as a reception unit which receives the reservation of the user who tries to use the space 2.

The target D includes a user certification unit 11 which performs certification of the user, a usage detection unit 12 which detects an operation in a case where the user performs the certification, a reservation checking unit 13 which checks a reservation with respect to the management server 5, a usage propriety determination unit 14 which determines propriety of the usage of the user, and an abnormality alarm unit 15 which issues an alarm in a case where the usage of the user is not possible.

The user certification unit 11 is a unit for identifying the user and performing the certification. In a case of a unit which is capable of identifying the user, a form as the user certification unit 11 does not matter. The user certification unit 11 includes, for example, an IC card, an IC card reader, a device which performs ecology certification, such as fingerprint certification or face certification, a smart key, a recording medium such as a barcode printed paper, a barcode reader, and the like. In addition, the user terminal 4 may be used as the user certification unit 11. In this case, for example, it is possible to use the NFC 406 (see FIG. 3) as the user certification unit 11. In a case where the user tries to use the space 2 which is a reservable space capable of being lent to a specified user, the user certification unit 11 functions as a recognition unit which recognizes the user.

The usage detection unit 12 detects that an operation for the certification of the user is performed. That is, in a case where the user performs the certification, it is necessary to perform any operation with respect to the target D. The usage detection unit 12 detects the operation at this time. Accordingly, the usage detection unit 12 functions as a detection unit which detects an operation performed by the user with respect to the target D. The usage detection unit 12 is, for example, a wireless communication module using Radio Frequency Identification (RFID) for reading and writing data of a tag using the wireless communication. In addition, as another form, the usage detection unit 12 may be, for example, a wireless communication module which performs the wireless communication using the NFC. Further, for example, the usage detection unit 12 detects an operation of holding up the user certification unit 11, such as the IC card, to the wireless module by the user who makes the reservation, as an operation which is performed on the target D by the user.

In addition, the usage detection unit 12 is not limited to the wireless communication module, and may be an acceleration sensor, an illuminance sensor, a magnetic sensor, or the like. In a case of the acceleration sensor, movement of the target D is detected. That is, as the operation for the certification of the user, acceleration is added to the target D in a case where the user moves the target D. Therefore, it is possible to detect the operation of the user using the acceleration. In addition, in a case of the illuminance sensor, a change in illuminance is detected in a case where the target D is moved. Further, in a case of the magnetic sensor, a change in magnetism is detected in the case where the target D is moved. In this case, the usage detection unit 12 detects an operation of moving the target D as the operation which is performed by the user with respect to the target D.

Further, the usage detection unit 12 may be built in furniture, such as the table, to detect the operation of the user. For example, for the table, the usage detection unit 12 may be a sensor, such as a mechanical type sensor, which detects operations of pulling out the table, putting something on the table, touching the table by the user. In addition, for the chair, the usage detection unit 12 may be a sensor, such as the mechanical type sensor, which detects operations of pulling out the chair, sitting on the chair by the user, and the like. Further, the usage detection unit 12 may be a sensor which detects operations of turning on power, putting into a socket, coupling to Wi-Fi, releasing lock, opening a curtain, and the like. Further, the usage detection unit 12 may use image recognition. For example, the usage detection unit 12 may monitor the furniture, such as the chair, which is the target D, using cameras, and may detect a change in a position.

In addition, further, the usage detection unit 12 may be acquired by combining the above-described wireless communication module, the sensor, and the like. For example, the usage detection unit 12 may be acquired by combining the mechanical type sensor with the wireless communication module. In this case, the mechanical type sensor detects the operation performed for the above-described table or chair by the user. Further, polling is performed by the wireless communication module only in a case where the operation is detected, and a process of checking the reservation, which will be described later, is performed. Therefore, it is not necessary to always couple the wireless communication module to the access point 6, and thus it is possible to reduce power consumption.

The reservation checking unit 13 checks the reservation of the user who tries to use the space 2. The reservation checking unit 13 is, for example, the wireless communication module which is capable of coupling to the access point 6, and performs the wireless communication with the access point 6 through the wireless communication line such as Wi-Fi. Further, the reservation checking unit 13 checks whether or not the reservation of the certified user is made with the management server 5 through the access point 6.

The usage propriety determination unit 14 determines propriety of the usage of the user who tries to use the space 2. The usage propriety determination unit 14 determines the propriety of the usage of the user who tries to use the space 2 based on a result of the reservation check, which is performed on the management server 5 by the reservation checking unit 13. As a result, in a case where the reservation is made, the usage propriety determination unit 14 allows the usage of the user. In contrast, in a case where the reservation is not made, the usage propriety determination unit 14 does not allow the usage of the user. In this case, in a case where the usage of the space 2 is allowed to the recognized user, the usage propriety determination unit 14 functions as a switch unit which switches from the state of blocking the usage of the space 2 by the user to a state of not blocking the usage of the space 2.

The usage propriety determination unit 14 is, for example, an integrated computer which is built in the target D. Meanwhile, it is possible to use the user terminal 4 as the usage propriety determination unit 14.

The usage propriety determination unit 14 may allow usage of equipment other than the space 2. The equipment other than the space 2 is, for example, equipment which is commonly used by a plurality of users who use the space 2. Further, specifically, a copy machine, a facsimile, or a beverage server, which supplies water, coffee, or the like, corresponds to the equipment. In a case where the usage propriety determination unit 14 has a linkage function, such as Single Sign-On, it is possible to realize the usage of the equipment other than the space 2.

In the exemplary embodiment, in a case where the reservation is made, the usage of the space 2 is allowed to the user. Further, in a case where an authority of the user who makes the reservation to use the space 2 including the target D is set as a first authority, it is possible to set an authority to use the target, such as the equipment other than the space 2, as a second authority. In addition, viewed from another angle, in a case where the user makes the reservation to use the space 2, the first authority is given to the user as a predetermined authority. Further, in a case where the usage of the space 2 is allowed by the usage propriety determination unit 14, the second authority is further given to the user. Accordingly, the usage propriety determination unit 14 functions as an addition unit which, in a case where the usage of the space 2 is allowed, additionally gives the second authority to the user as the predetermined authority other than the authority to use the space 2.

The abnormality alarm unit 15 is an example of a warning unit, and gives a warning in a case where the usage detection unit 12 detects the above-described operation of the user. Further, the abnormality alarm unit 15 blocks the usage of the space 2 by issuing the alarm. Although it is possible to issue the alarm by, for example, sounding a buzzer, blinking a lamp, or the like, the present invention is not limited thereto. For example, physical stimulation may be given to the user as in a case where feeble currents are fed to a place touched by hands of the user or the target D is vibrated. In addition, a notification may be provided to a manager of the space 2 or a security official. Further, in a case where reservation time is exceeded, the abnormality alarm unit 15 may call attention of the user.

Further, in a case where the usage of the space 2 by the user is allowed, the abnormality alarm unit 15 stops the warning. That is, there is a case where the user certification unit 11 performs the certification of the user after the usage detection unit 12 detects the above-described operation of the user. At this time, first, the warning is given with respect to the user according to the detection of the operation. Thereafter, the user certification unit 11 recognizes the user, and the abnormality alarm unit 15 stops the warning in a case where the usage propriety determination unit 14 allows the usage of the space 2.

Subsequently, a detailed example of a case where the user tries to use the space 2 will be described.

Parts (a) to (f) in FIG. 6 are diagrams illustrating a first detailed example in a case where the user tries to use the space.

The part (a) in FIG. 6 illustrates the space 2 according to the first detailed example.

As illustrated in the drawing, four spaces 2 exist, and four users are capable of using the respective spaces 2. Further, the respective spaces 2 are provided with a stuffed doll D0, the table D1, and the chair D2, respectively. The stuffed doll D0, the table D1, and the chair D2 are examples of the target D, respectively.

The part (b) in FIG. 6 illustrates a state of the stuffed doll D0 and the table D1 before the usage of the user.

As illustrated in the drawing, the stuffed doll D0 is placed on the table D1. That is, in a case where the stuffed doll D0 is placed, it is not possible to use the table D1, and thus the state of blocking the usage of the space 2 by the user is made. Further, an RFID tag Rf1 is attached to the table D1, and performs the wireless communication with a RFID Rf0 (see the part (c) in FIG. 6) provided on a lower side of the stuffed doll D0. Therefore, it is detected that the stuffed doll D0 is in a state of not moving.

The part (c) in FIG. 6 illustrates a state in which the user who makes the reservation for the space 2 lifts up the stuffed doll D0 and holds up an IC card C to the RFID Rf0 provided on the lower side of the stuffed doll D0. At this time, a state is made in which the RFID Rf0 reads information of the IC card C. That is, the state corresponds to a state in which the usage detection unit 12 detects an operation of lifting up the stuffed doll D0 by the user in such a way that the RFID Rf0 starts the wireless communication. Meanwhile, in a case where the wireless communication with the RFID tag Rf1 is not possible or radio field intensity becomes small, the operation of lifting up the stuffed doll D0 by the user may be detected. Further, the state corresponds to a case where the user certification unit 11 performs the certification of the user.

The part (d) in FIG. 6 illustrates a state in which the usage of the space 2 is allowed with respect to the user.

That is, the state is a state in which a built-in computer, which is not shown and is provided in the stuffed doll D0, checks the reservation with respect to the management server 5 and, as a result, allows the usage of the space 2 with respect to the user. The state corresponds to a case where the usage propriety determination unit 14 allows the usage of the space 2. The state is a state acquired after switching from the state of blocking the usage of the space 2 by the user to the state of not blocking the usage of the space 2.

In contrast, the part (e) in FIG. 6 illustrates a state in which the stuffed doll D0 is simply moved from the state of the part (b) in FIG. 6 without holding up the IC card C to the RFID Rf0.

In the state, the wireless communication with the RFID tag Rf1 is not possible or the radio field intensity becomes small. As a result, it is possible to detect an operation of moving the stuffed doll D0 by the user. Further, at this time, in a case where the user certification unit 11 does not perform the certification of the user, the usage propriety determination unit 14 determines to not allow the usage of the user.

The part (f) in FIG. 6 illustrates a state in which the stuffed doll D0 issues the alarm after the part (e) in FIG. 6.

This state corresponds to a state in which the abnormality alarm unit 15 issues the alarm as a result that the usage propriety determination unit 14 does not allow the usage of the user. Meanwhile, in a case where the user holds up the IC card C to the RFID Rf0 in the state, the state of the part (c) in FIG. 6 is made, and thus the alarm stops. It is possible to consider the case as the state acquired after switching from the state of blocking the usage of the space 2 by the user to the state of not blocking the usage of the space 2.

In the cases of the parts (a) to (f) in FIG. 6, the state of blocking the usage of the space 2 by the user (the state of the part (b) in FIG. 6) is made because the stuffed doll D0 is placed on the table D1. In addition, in a case where the user moves the stuffed doll D0 (the state of the part (e) in FIG. 6), the stuffed doll D0 issues the alarm, and thus the state (the state of the part (f) in FIG. 6) of blocking the usage of the space 2 by the user is made. Further, in a case where the user performs the certification (the state of the part (c) in FIG. 6), the alarm is not issued or stops, thereby being a state after switching from the state of blocking the usage of the space 2 by the user to the state of not blocking the usage of the space 2 (the state of the part (d) in FIG. 6).

Meanwhile, although the stuffed doll D0 is used in the above-described examples, the present invention is not limited thereto and any object is sufficient which is placed on the table D1 and blocks the usage of the user. Accordingly, for example, the object may be a plate on which text, such as “reserved”, is written.

Parts (a) and (b) in FIG. 7 are diagrams illustrating a second detailed example of the case where the user tries to use the space 2.

The part (a) in FIG. 7 illustrates a state before the user uses the space 2. As illustrated in the drawing, the space 2 includes the table D1 and the chair D2. Each of the table D1 and the chair D2 is an example of the target D.

Further, in the state of the part (a) in FIG. 7, the chair D2 is close to a side of the table D1 and is locked by a lock mechanism R1. The lock mechanism R1 is, for example, an electronic key. Therefore, it is not possible for the user to pull out and sit on the chair D2. That is, in the state of the part (a) in FIG. 7, the usage of the chair D2 is not possible, and thus the state of blocking the usage of the space 2 by the user is made.

The part (b) in FIG. 7 illustrates a state in which the user uses the space 2.

The state corresponds to a case where the user holds up the IC card (not shown in the drawing) to an RFID (not shown in the drawing) included in the table D1 and the usage propriety determination unit 14 allows the usage of the space 2 as a result that the user certification unit 11 performs the certification of the user. In the state of the part (b) in FIG. 7, locking of the lock mechanism R1 is released, and thus it is possible to pull out the chair D2 as shown in the drawing. The state is the state acquired after switching from the state of blocking the usage of the space 2 by the user to the state of not blocking the usage of the space 2. In the state, it is possible for the user to use the space 2 which includes the table D1 and the chair D2.

Parts (a) to (c) in FIG. 8 illustrate a third detailed example of the case where the user tries to use the space 2.

The part (a) in FIG. 8 illustrates a state before the user uses the space 2. As illustrated in the drawing, the space 2 includes the table D1. The table D1 is an example of the target D.

Further, in a state of the part (a) in FIG. 8, the table D1 is in a perpendicular state, and it is not possible to use the table D1 after horizontalizing the table D1. That is, in the state of the part (a) in FIG. 8, it is not possible for the user to use the table D1, and thus the state of blocking the usage of the space 2 by the user is made.

The part (b) in FIG. 8 illustrates a state in which the user tries to use the space 2. The state corresponds to the case where the user holds up the IC card (not shown in the drawing) to the RFID (not shown in the drawing) included in the table D1 and the usage propriety determination unit 14 allows the usage of the space 2 as the result that the user certification unit 11 performs the certification of the user. In the part (b) in FIG. 8, in a case where the user horizontalizes the table D1, the lock mechanism R2 is operated.

Further, as in the part (c) in FIG. 8, the table D1 is locked in a state of being horizontalized by the lock mechanism R2. The state is the state acquired after switching from the state of blocking the usage of the space 2 by the user to the state of not blocking the usage of the space 2. In the state, it is possible for the user to use the space 2 which includes the table D1. The lock mechanism R2 turns up and down by, for example, a solenoid. The table D1 is not locked in a state in which the lock mechanism R2 turns down and it is possible to lock the table D1 in a state in which the lock mechanism R2 turns up. Meanwhile, in a case where reserved time is exceeded, the lock mechanism R2 may be released and the table D1 may be returned to an original perpendicular state.

Example of Management Data

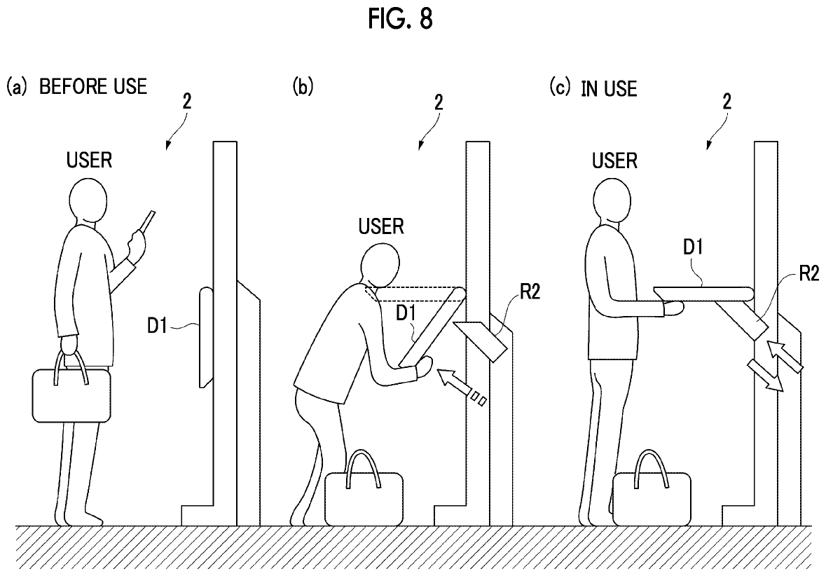

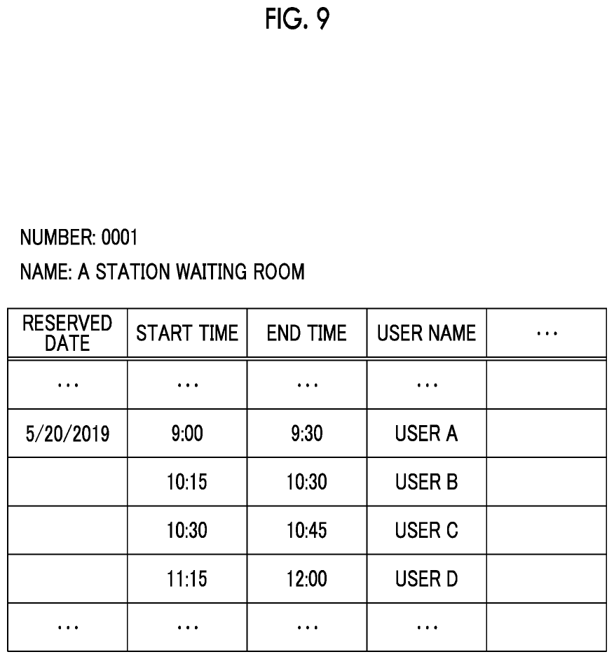

FIG. 9 is a diagram illustrating an example of management data managed by the management server 5.

The management server 5 according to the exemplary embodiment manages reservation information for every space 2 on which the reservation is made.

The management data illustrated in FIG. 9 is an example of the space 2 which has a number “0001” and a name “A station waiting room”.

In a case of FIG. 9, the management data for the reservation includes a reservation date, start time, end time, a user name, and the like. For example, a “user A” makes a reservation for a time zone from “9: 00” to “9: 30” in “2019/5/20”.

In the case of FIG. 9, a reservation unit is a unit of 15 minutes. However, the reservation unit may be another unit such as a unit of 10 minutes.

Operation of Management System 1

Subsequently, an operation of the management system 1 will be described.

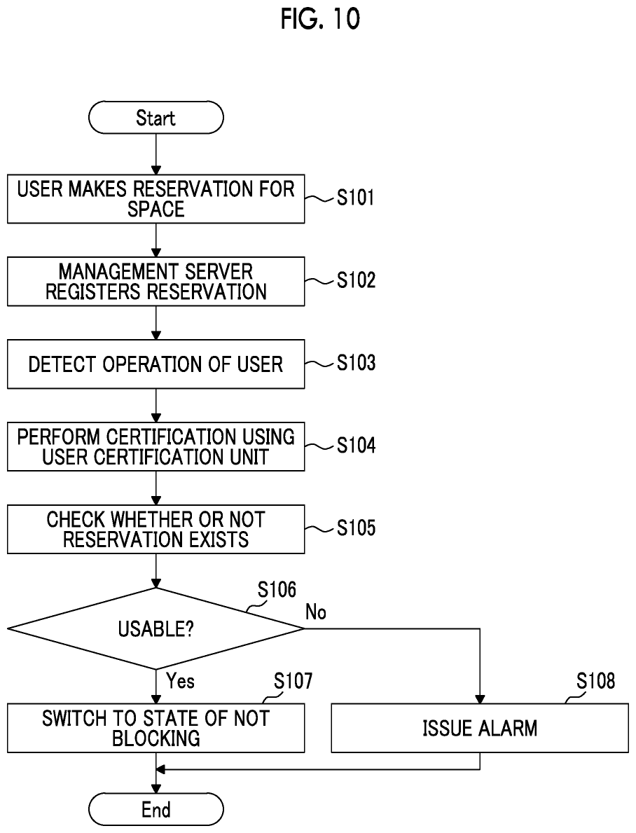

FIG. 10 is a flowchart illustrating a whole operation of the management system 1 according to the first exemplary embodiment.

First, the user makes the reservation for the space 2 using the user terminal 4 (step S101). The user operates an application for making the reservation for the space 2, a browser for displaying a site on which the reservation is made, or the like, using the user terminal 4, and makes the reservation for the space 2 using the application, the browser, or the like.

Further, the management server 5 registers the reservation received from the user terminal 4 (step S102). Meanwhile, here, a case where the reservation for the space 2 succeeds will be described. Since the case where it is not possible to make the reservation is described above, the description thereof will not be repeated.

Subsequently, the usage detection unit 12 detects the operation in the case where the user performs the certification (step S103). As described above, the operation is performed by, for example, the RFID or the like.

Further, the user appears at a place corresponding to the space 2 on reserved date and time, and performs the certification using the user certification unit 11 of the target D (step S104). At this time, in a case where the user holds up the IC card or the like, the user certification unit acquires information of the user, and performs the certification of the user.

Further, the reservation checking unit 13 inquires of the management server 5 about whether or not the reservation exists, and checks whether or not the certified user is the subscriber (step S105).

As a result of the check, the usage propriety determination unit 14 determines whether or not to allow the certified user to use the space 2 (step S106).

Further, in a case where the usage is allowed (Yes in step 106), the usage propriety determination unit 14 switches the target D from the state of blocking the usage of the space 2 by the user to the state of not blocking the usage of the space 2 (step S107).

In contrast, in a case where the usage is not allowed (No in step 106), the abnormality alarm unit 15 issues the alarm (step S108).

### Second Exemplary Embodiment

Detailed Description of Management System 1

Subsequently, a second exemplary embodiment of the management system 1 will be described. In the second exemplary embodiment, the user does not make the reservation to use the space 2. Hereinafter, a case will be described where the user appears at the place of the space 2, makes a payment for usage fees at the place, and uses the space 2. Accordingly, the authority to use the space 2 is given to the user in a case where the payment to use the space 2 is made.

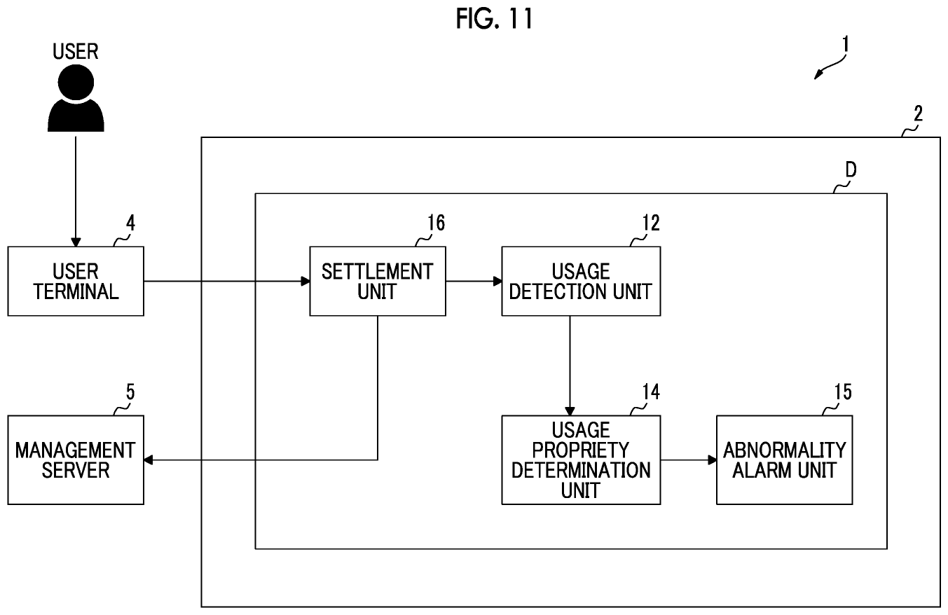

FIG. 11 is a block diagram illustrating a functional configuration of the management system 1 according to the second exemplary embodiment.

Compared to the management system 1 illustrated in FIG. 5, the management system 1 illustrated in the drawing is different in a fact that the user certification unit 11 and the reservation checking unit 13, which check the reservation, do not exist and a payment unit 16 which performs a payment process is added, and others are the same. Accordingly, hereinafter, the fact that is different from the management system 1 illustrated in FIG. 5 will be mainly described.

The payment unit 16 makes a payment for usage fees of the space 2. Although the payment unit 16 is, for example, Felica (registered trademark), the payment unit 16 is not limited thereto and may be electronic money using a barcode or the like. In addition, the payment unit 16 may be a device which performs the payment using cash, a pre-paid card, or a credit card. Further, the payment unit 16 may be a device which records usage history and calculates charges through additional manual work or the like.

In addition, in the second exemplary embodiment, the user terminal 4 is not a device which is definitely necessary. For example, the user terminal 4 is used for the user who is desired to use the space 2 to search for the space 2 which can be used. In addition, it is possible to make the payment using the NFC 406 of the user terminal 4, instead of the payment unit 16. In addition, the management server 5 manages the payment process performed by the payment unit 16. Further, the management server 5 manages the history and performs a process for an account transferring or the like.

Operation of Management System 1

Subsequently, an operation of the management system 1 will be described.

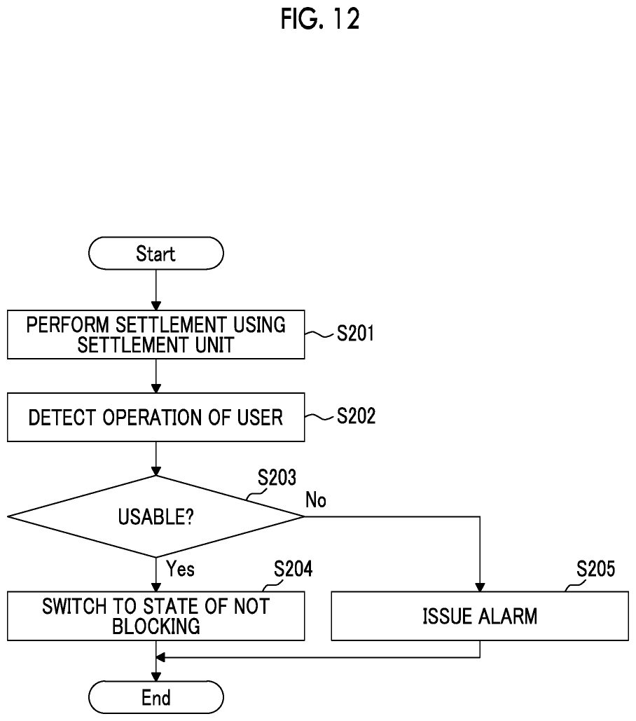

FIG. 12 is a flowchart illustrating a whole operation of the management system 1 according to the second exemplary embodiment.

First, the user appears at the place of the space 2, and performs the payment using the payment unit 16 of the target D (step S201). At this time, in a case where the user holds up a Felica card or the like to a reading device, the payment unit 16 performs the payment process.

Further, the usage detection unit 12 detects an operation in a case where the user performs the payment (step S202). The steps are the same as in the first exemplary embodiment.

Further, the usage propriety determination unit 14 determines whether or not to allow the user to use the space 2 (step S203). In principle, in a case where the payment is completed, the user is allowed.

Further, in a case where the usage is allowed (Yes in step S203), the usage propriety determination unit 14 switches the target D from the state of blocking the usage of the space 2 by the user to the state of not blocking the usage of the space 2 (step S204).

In contrast, in a case where the usage is not allowed (No in step S203), the abnormality alarm unit 15 issues the alarm (step S205).

In a case where the space 2 is the open space at which locking or the like is not performed, the space 2 is normally can be used without reservation or payment. In contrast, in the exemplary embodiment, a function of blocking the usage of the user is given to the target D, such as the equipment or the fixtures, included in the space 2, and, with respect to the user who performs the reservation or the payment, switch is performed from the state of blocking the usage of the user to the state of not blocking the usage of the user. However, in a case where the reservation or the payment is not made, the state of blocking the usage of the user is not released, and the state of blocking the usage of the user remains. Therefore, it is possible to easily manage the space 2 which is a reservable space capable of being lent.

Further, compared to a case where the space 2 is a locking space on which the locking or the like is performed, it is possible to make cost required for the management of the space 2 low without requiring cost of facility production, locking management, or the like. Further, compared to the case of the locking space, it is also possible to reduce the occupied area required for the management.

In addition, in the above-described exemplary embodiment, the operation is detected in the case where the certification of the user is performed. Further, in a case where the operation is detected, the user certification unit 11, which performs the certification of the user, and the abnormality alarm unit 15, which gives a warning with respect to the user, are triggered to be operated. Therefore, it is possible to reduce the power consumption, and it is easy to detect the user who tries to use the space 2.

Description of Program

Here, the process, which is performed by the target D in the exemplary embodiment described as above, is prepared as, for example, a program such as application software. Further, the process, which is performed by the target D, is realized in such a way that software works together with hardware sources.

Accordingly, in the exemplary embodiment, it is possible to understand a program, which executes the process performed by the target D, as a program for causing a computer to realize a recognition function of recognizing a user in the space 2 which is a reservable space capable of being lent to a specified user, and a switch function of switching from the state of blocking usage of the space 2 by the user to the state of not blocking the usage of the space 2 in the case where the usage of the space 2 is allowed to the recognized user.

Meanwhile, it is apparent that it is possible to provide the program which realizes the exemplary embodiment by communication means, and is also possible to provide the program by storing the program in a recording medium such as a CD-ROM.

Hereinabove, the exemplary embodiments are described, a technical scope of the present invention is not limited to scopes described in the exemplary embodiments. It is clear that various changes or modifications of the exemplary embodiments are included in the technical scope of the present invention from the claims.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a recognition unit that recognizes arrival of user at a reservable space; and
a switch unit that, in a case where the user is allowed to use the reservable space, switches from a state of blocking usage of the reservable space to a state of not blocking the usage of the reservable space.

2. The information processing apparatus according to claim 1,
wherein the switch unit allows the usage of the reservable space to the user in a case where the user has a predetermined authority to use the reservable space.

3. The information processing apparatus according to claim 2,
wherein the authority is given to the user in a case where a reservation to use the reservable space is made.

4. The information processing apparatus according to claim 2,
wherein the authority is given to the user in a case where payment to use the reservable space is made.

5. The information processing apparatus according to claim 1, further comprising:
a detection unit that detects an operation performed on the information processing apparatus by the user,
wherein the recognition unit recognizes the user in a case where the detection unit detects the operation.

6. The information processing apparatus according to claim 5,
wherein the operation is an operation of moving the information processing apparatus.

7. The information processing apparatus according to claim 5, further comprising:
a warning unit that gives a warning in a case where the detection unit detects the operation.

8. The information processing apparatus according to claim 7,
wherein the warning unit blocks the usage of the reservable space by issuing an alarm.

9. The information processing apparatus according to claim 7,
wherein the warning unit stops the warning in a case where the usage of the reservable space is allowed to the user.

10. The information processing apparatus according to claim 2, further comprising:
an addition unit that additionally gives a second authority to the user as the predetermined authority other than the authority to use the reservable space in a case where the usage of the reservable space is allowed.

11. The information processing apparatus according to claim 10,
wherein the second authority is used to allow usage of a target other than the reservable space.

12. A reservation system comprising:
a reservable space;
a reception unit that receives a reservation of the reservable space; and
an information processing unit that allows a user to use the reservable space, the reservable space being reserved for the user by the reservation,
wherein the information processing unit includes
a recognition unit that recognizes arrival of the user at the reservable space, and
a switch unit that, in a case where the user is allowed to use the reservable space, switches from a state of blocking the usage of the space to a state of not blocking the usage of the space.

13. A non-transitory computer readable medium storing a program causing a computer to realize
a recognition function of recognizing arrival of a user at a reservable space; and
a switch function of switching, in a case where the recognized user is allowed to use the reservable space, from a state of blocking usage of the space to a state of not blocking the usage of the space.
